(19) United States
(12) Patent Application Publication
(10) Pub. No.: US 2023/0418873 A1
(43) Pub. Date: Dec. 28, 2023

(54) QUERY INTERPRETER TRAINING WITH ADVERSARIAL TABLE PERTURBATIONS

(71) Applicant: Microsoft Technology Licensing, LLC, Redmond, WA (US)

(72) Inventors: Yan GAO, Beijing (CN); Jianguang LOU, Beijing (CN); Dongmei ZHANG, Beijing (CN)

(73) Assignee: Microsoft Technology Licensing, LLC, Redmond, WA (US)

(21) Appl. No.: 17/808,281

(22) Filed: Jun. 22, 2022

(51) Int. Cl. G06F 16/9032; G06N 20/00; G06N 5/04

(52) U.S. Cl. CPC G06F 16/90332; G06N 20/00; G06N 5/04

(57) ABSTRACT

A set of adversarial training examples for training a query interpreter are generated by: obtaining a target data table for a natural language query; identifying a primary entity of the target data table; for a target domain of the target data table, generating a set of candidate identifiers that are each semantically associated with an identifier of the target domain; for each candidate identifier, providing a premise-hypothesis pair to an NLI model to generate an entailment score; selecting a first subset of candidate identifiers from among the set of candidate identifiers based on the entailment score generated for each premise-hypothesis pair; for each candidate identifier of the first subset, applying the candidate identifier to an instance of the target data table as a table perturbation to generate a perturbed data table; and outputting each perturbed data table as part of an adversarial training example.

### BACKGROUND

Databases may include data tables having domains (e.g., columns) and associated field values that can be queried and modified by users. Some database systems support natural language (NL) queries through use of a query interpreter that translates an NL query into a structured language (SL) query that can be applied to a database. Modifications to a database, such as renaming of columns or adding new columns can negatively impact performance of NL-to-SL query interpreters.

### SUMMARY

According to an example, training of a computer-implemented query interpreter for a database system is disclosed. At a computing system, a set of one or more adversarial training examples are generated for training the query interpreter.

As input, a target data table for a natural language query is obtained by the computing system, and a primary entity of the target data table is identified. For a target domain of the target data table, a set of candidate identifiers are generated.

The set of candidate identifiers are each semantically associated with an identifier of the target domain. For each candidate identifier, a premise-hypothesis pair is provided to a natural language inference (NLI) model to generate an entailment score. As an example, the premise of the premise-hypothesis pair includes an identifier of the primary entity and the identifier of the target domain, and the hypothesis of the premise-hypothesis pair includes the identifier of the primary entity and the candidate identifier.

A first subset of candidate identifiers (e.g., suitable for add-type perturbations or for replace type perturbations) are selected from among the set of candidate identifiers based on the entailment score generated for each premise-hypothesis pair. For each candidate identifier of the first subset, the candidate identifier is applied to an instance of the target data table as a table perturbation to generate a perturbed data table. Examples of table perturbations include replace-type perturbations exhibiting higher semantic equivalency as indicated by the entailment score, and add-type perturbations exhibiting lower semantic equivalency as indicated by the entailment score.

Each perturbed data table is output as part of an adversarial training example of the set of one or more adversarial training examples for training the query interpreter. In at least some examples, each adversarial training example may further include the NL query for which the perturbed data tables were generated and the target data table or an identifier of the target data table.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 depicts features of an example data flow within a computing system of one or more computing devices.

FIG. 2 depicts a database in which example table perturbations are applied to a data table.

FIG. 3 depicts additional features of a contextualized table augmentation framework of FIG. 1.

FIG. 4 a flow diagram depicting an example method to facilitate training of a computer-implemented query interpreter for a database system.

FIG. 5 depicts an example of the contextualized table augmentation framework of FIGS. 1 and 3 performing the method of FIG. 4 using an example natural language query and target data table.

FIG. 6 is a schematic diagram of an example computing system of one or more computing devices.

### DETAILED DESCRIPTION

Databases, as introduced briefly above, may include data tables having domains (e.g., columns) and associated field values that can be queried and modified by users. Some database systems support natural language (NL) queries through use of a query interpreter that translates an NL query into a structured language (SL) query that can be applied to a database. Modifications to a database, such as renaming of columns or adding new columns can negatively impact performance of NL-to-SL query interpreters.

As an example, the robustness of NL-to-SL query interpreters (e.g., natural language text-to-SQL parsers) against adversarial perturbations may play a significant role in delivering highly reliable applications. Additional lexicon diversity introduced by modifications to data tables may, for example, harm performance of less robust NL-to-SL query interpreters.

Given a natural language (NL) query (e.g., a text-based natural language query) and a target data table for the NL query as input, a set of adversarial training examples may be programmatically generated by a computer-implemented contextualized table augmentation (CTA) framework. The adversarial training examples may be used to facilitate training of a query interpreter for a database system, such an NL-to-SL query interpreter, as an example.

The CTA framework disclosed herein has the potential to reduce or eliminate human involvement in generating adversarial training examples that may be used to train a query interpreter. Additionally or alternatively, the CTA framework has the potential to increase the quantity and/or quality of adversarial training examples for a given level of human involvement. By training query interpreters with adversarial training examples having table perturbations, performance of the query interpreters on NL queries can be improved in real-world scenarios in which data tables of a database system have been perturbed through user interaction with the database system.

In at least some examples, each adversarial training example may include a perturbed data table having: (1) an added domain (e.g., an added column) and associated domain identifier (e.g., a column identifier, such as a column name), referred to herein as an add-type perturbation; and/or (2) a replacement domain identifier (e.g., a column identifier, such as a column name) that replaces an existing domain identifier within the target data table, referred to herein as a replace-type perturbation. Add-type and replace-type perturbations may be referred to as adversarial table perturbations (ATP).

Domain identifiers that replace existing domain identifiers within the target data table and domain identifiers for domains added to the target data table may be programmatically generated by the CTA framework based on contextual information obtained from the NL query and/or the target data table for the NL query. Natural language inference (NLI) models may be used to distinguish add-type perturbations from replace-type perturbations based on a premise-hypothesis pair that is constructed for each candidate identifier using contextual information of the target data table. Such contextual information may include a primary entity of the target data table, an identifier of the target domain for the NL query, and a data type of fields of the target domain, as examples.

Probabilities of semantic equivalency generated by NLI models (e.g., as entailment scores) may be used to distinguish candidate identifiers suitable for replace-type perturbations from candidate identifiers suitable for add-type perturbations. In at least some examples, the NLI models disclosed herein may take the form of a Multi-NLI model (MNLI). As one example, the RoBERTa-MNLI model may be used as the NLI models disclosed herein. However, it will be appreciated that other suitable MNLI models may be used, including Single-NLI (SNLI) models, as an example.

According to an example, training of a computer-implemented query interpreter for a database system is disclosed. At a computing system, a set of one or more adversarial training examples are generated for training the query interpreter. A natural language query and a target data table for the natural language query are obtained. A primary entity of the target data table is identified.

For a target domain of the target data table, a set of candidate identifiers are generated. The set of candidate identifiers are each semantically associated with an identifier of the target domain. For each candidate identifier, a premise-hypothesis pair is provided to a natural language inference (NLI) model to generate an entailment score. As an example, the premise of the premise-hypothesis pair includes an identifier of the primary entity and the identifier of the target domain, and the hypothesis of the premise-hypothesis pair includes the identifier of the primary entity and the candidate identifier.

A first subset of candidate identifiers (e.g., for replace-type perturbations or for add-type perturbations) are selected from among the set of candidate identifiers based on the entailment score generated for each premise-hypothesis pair. For each candidate identifier of the first subset, the candidate identifier is applied to an instance of the target data table as a table perturbation to generate a perturbed data table. Such table perturbations may include replace-type perturbations exhibiting higher semantic equivalency as indicated by the entailment score, and add-type perturbations exhibiting lower semantic equivalency as indicated by the entailment score.

Each perturbed data table is output as part of an adversarial training example of the set of one or more adversarial training examples for training the query interpreter. In at least some examples, each adversarial training example may further include the NL query for which the perturbed data tables were generated and the target data table or an identifier of the target data table.

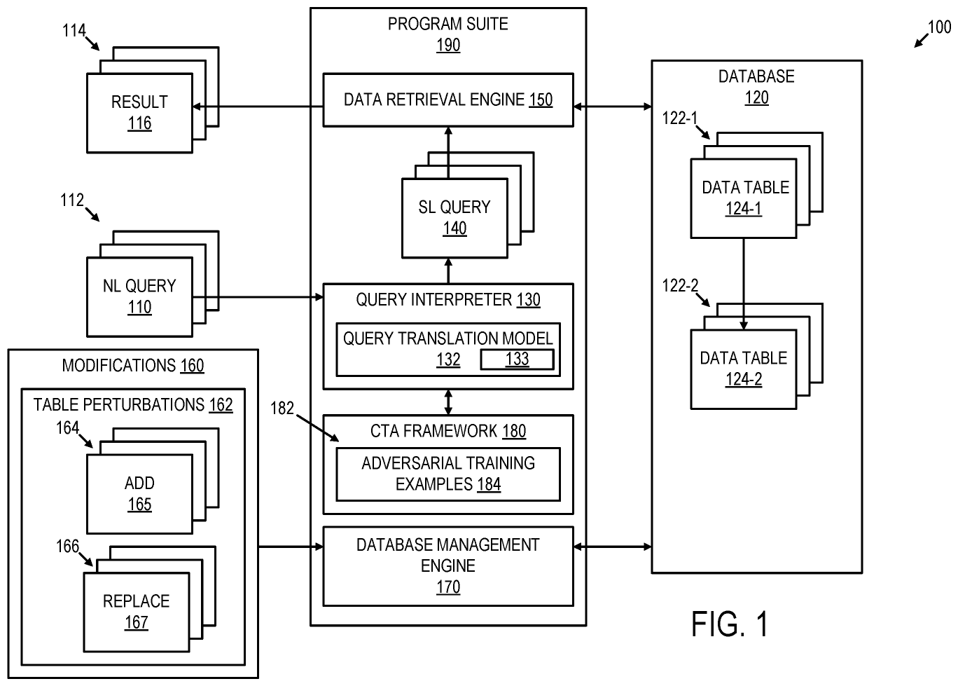

FIG. 1 depicts features of an example data flow 100 within a computing system of one or more computing devices. Within data flow 100, an NL query 110 on a database 120 is received by a query interpreter 130, which translates NL query 110 to an SL query 140. In this role, query interpreter 130 may be referred to as an NL-to-SL or as an NL-SL query interpreter. NL queries 112 of which NL query 110 is an example may be received as input from a database user or from a computer-implemented process, as examples. As an example, query interpreter 130 interpreter interprets natural language queries into structured queries of a structured query language (e.g., SQL or other suitable structured query language supported by a database system).

A data retrieval engine 150 receives SL queries 142, of which SL query 140 is an example. SL queries 142 that were translated by query interpreter 130 are processed by data retrieval engine 150, which retrieves data from database 120 based on the SL queries. As an example, data retrieval engine 150 is configured to perform data search and retrieval operations based on SL queries that are formatted according to the structured query language. Database 120 may include a set of one or more data tables 122-1 of which data table 124-1 is an example. Data retrieved by data retrieval engine 150 for NL queries 112 may be output as results 114. As an example, result 116 may be output by data retrieval engine responsive to NL query 110.

As an illustrative example, NL query 110 may include a question, such as: “Students with score >90?”, and data table 124-1 (as a target data table for NL query 110) may include a column of student names and a column of scores in which each score is associated with a respective student name. In this example, result 116 output by data retrieval engine 150 based on SL query 140 translated by query interpreter 130 from NL query 110 may include one or more student names that are associated with a score that is greater than 90.

Database 120 may be modified from time to time with modifications 160. As an example, a database management engine 170 may receive modifications 160 as input and perform the modifications on database 120. Modifications 160 on database 120 by database management engine 170 may generate a modified versions 122-2 of one or more of data tables 122-1. As an example, data table 124-1 may be modified by database management engine 170 responsive to modifications 160 to obtain a modified version 124-2 of the data table. Modifications 160 may be received as input from an administrator user or from a computer-implemented process, as examples.

Modifications 160 may include table perturbations 162. As examples, table perturbations 162 may include add-type perturbations 164 of which add-type perturbation 165 is an example, and replace-type perturbations 166 of which replace-type perturbation 167 is an example.

Add-type perturbations 164 refer to the addition of a domain (e.g., a column) having a domain identifier to a data table, such as data table 124-1. As an example, a domain having an identifier (e.g., “age”) may be added to data table 124-1 by database management engine 170 responsive to add-type perturbation 165 to generate modified version 124-2 of the data table. Modified version 124-2 may be referred to as a perturbed data table.

Replace-type perturbations 166 refer to replacement of an identifier of a domain (e.g., a column) with a different domain identifier. As an example, an identifier (e.g., “STUDENT”) of a domain within data table 124-1 may be replaced with another identifier (e.g., “PUPIL”) by database management engine 170 responsive to add-type perturbation 165 to generate modified version 124-2 as a perturbed data table.

Query interpreter 130 may include a query translation model 132 for translating NL queries to SL queries that is trained using a set of training data 182. As an example, query translation model 132 of query interpreter 130 may be trained using training data 182 that includes adversarial training examples 184 generated by a contextualized table augmentation (CTA) framework 180, as described in further detail herein. Training of query translation model 132 using adversarial training examples 184 may improve performance of query interpreter 130 in terms of results 114 that are generated responsive to NL queries 112.

In at least some examples, query translation model 132 may include or have access to a schema 133 that defines, for each of a plurality of terms, one or more links between a first term (e.g., a natural language word) and one or more additional terms (e.g., one or more additional natural language words) that are semantically associated with the first term. Such links may identify the semantic association as being semantically equivalent (e.g., two terms are semantically equivalent to each other) or non-equivalent, but semantically associated (e.g., two terms are not equivalent but have some semantic association). As part of training of query translation model 132, schema 133 may be updated to based on training examples, for example, by adding, adjusting, or eliminating links indicative of semantic association between terms. Query translation model 132 may use schema 133 and links defined therein to translate NL queries to SL queries, as an example.

As NL queries 112 include natural language, NL queries 112 may be expressed in a variety of ways using human language (e.g., English, Spanish, Japanese, etc.). As an example, NL query 110 such as: “Students with score>90?” may be alternatively expressed as “Pupils with score >90”. In this example, the term “Pupils” is considered to be semantically equivalent to the term “Students”. Query interpreter 130 (including query translation model 132 thereof) may be trained using adversarial training examples 184 to translate NL query variants to an SL query that generates the same or similar results across a range of the NL query variants.

Within FIG. 1, query interpreter 130, data retrieval engine 150, CTA framework 180, and database management engine 170 are depicted forming part of a program suite 190 of one or more computer-implemented programs. As an example, query interpreter 130, data retrieval engine 150, and database management engine 170 may form part of a first program (e.g., a database program), and CTA framework 180 may form part of a second program (e.g., a training program). As another example, query interpreter 130, data retrieval engine 150, CTA framework 180, and database management engine 170 may form part of the same program (e.g., a database program having training functionality). In still further examples, each of query interpreter 130, data retrieval engine 150, CTA framework 180, and database management engine 170 may form separate programs.

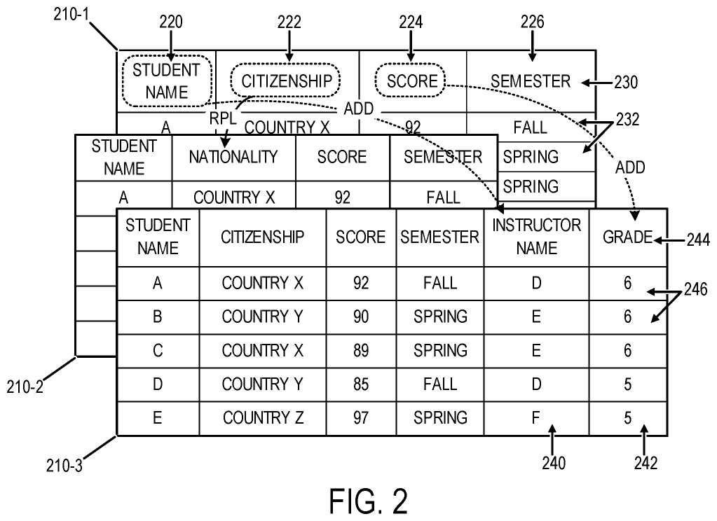

FIG. 2 depicts a database 200 in which example table perturbations are applied to a data table 210-1. Data table 210-1 is an example of previously described data table 124-1 of FIG. 1. In this example, data table 210-1 includes a plurality of domains 220, 222, 224, 226, etc. in the form of columns. Each domain of data table 210-1 includes a domain identifier 230. For example, domains 220, 222, 224, and 226 include the domain identifier: “STUDENT NAME”, “CITIZENSHIP”, “SCORE”, and “SEMESTER”, respectively.

Each domain further of data table 210-1 includes one or more associated field values 232 for that domain. For example, domain 226 identified as “SEMESTER” includes field values 232 such as “FALL” and “SPRING”. Field values of a data table may have one of a plurality of data types. Examples of data types include text, numeric values as integers, numeric values as decimals, Boolean (e.g., true, false, etc.), a time range, a date and/or time, a byte array, etc.

A perturbed data table 210-2 is depicted in FIG. 2 relative to data table 210-1 (as the source data table) in which the domain identifier “CITIZENSHIP” of domain 222 is replaced (RPL) with a different, replacement domain identifier “NATIONALITY”. Perturbed data table 210-2 is an example of modified version 122-2 of FIG. 1. Replacement of domain identifiers may be referred to as replace-type perturbations. Within the context of generating adversarial training examples, replacement-type perturbations may be defined as involving replacement by a replacement domain identifier that exhibits semantic similarity and semantic equivalency (e.g., a high probability of semantic equivalency) to the replaced domain identifier. For example, the replacement domain identifier “NATIONALITY” is semantically associated with and has a high semantic equivalency to the replaced domain identifier “CITIZENSHIP”.

Another perturbed data table 210-3 is depicted in FIG. 2 relative to data table 210-1 (as the source data table) in which new domains 240 and 242 are added. Perturbed data table 210-3 is another example of modified version 122-2 of FIG. 1. Addition of domains and domain identifiers may be referred to as add-type perturbations. In this example, each domain of perturbed data table 210-3 again includes a domain identifier 244. For example, within perturbed data table 210-3, domain 240 includes the domain identifier “INSTRUCTOR NAME” and domain 242 includes the domain identifier “GRADE”, which were not present in data table 210-1. Additionally, domains 240 and 242 each include associated field values 246.

Within the context of generating adversarial training examples, add-type perturbations may be defined as involving the addition of a domain and domain identifier that exhibits non-equivalent semantic similarity with other domain identifiers of the data table that are not semantically equivalent or exhibit low semantic equivalency (e.g., a low probability of semantic equivalency) with the other domain identifiers of the data table. In the example of perturbed data table 210-3, the added domain identifiers “INSTRUCTOR NAME” and “GRADE” of the add-type perturbation for the perturbed data table are each semantically associated with one or more other domain identifiers of the data table, such as “STUDENT NAME” of domain 220 and “SCORE” of domain 224. However, in contrast to replace-type perturbations, add-type perturbations are not semantically equivalent or have low semantic equivalency to domain identifiers of other existing domains within the data table. As an example, the domain identifier “INSTRUCTOR NAME” is not semantically equivalent to “STUDENT NAME” or other domains identified by the data table. As another example, the domain identifier “GRADE” is not semantically equivalent to “SCORE”, as the term “GRADE” is used to refer to a level of education within a range of levels.

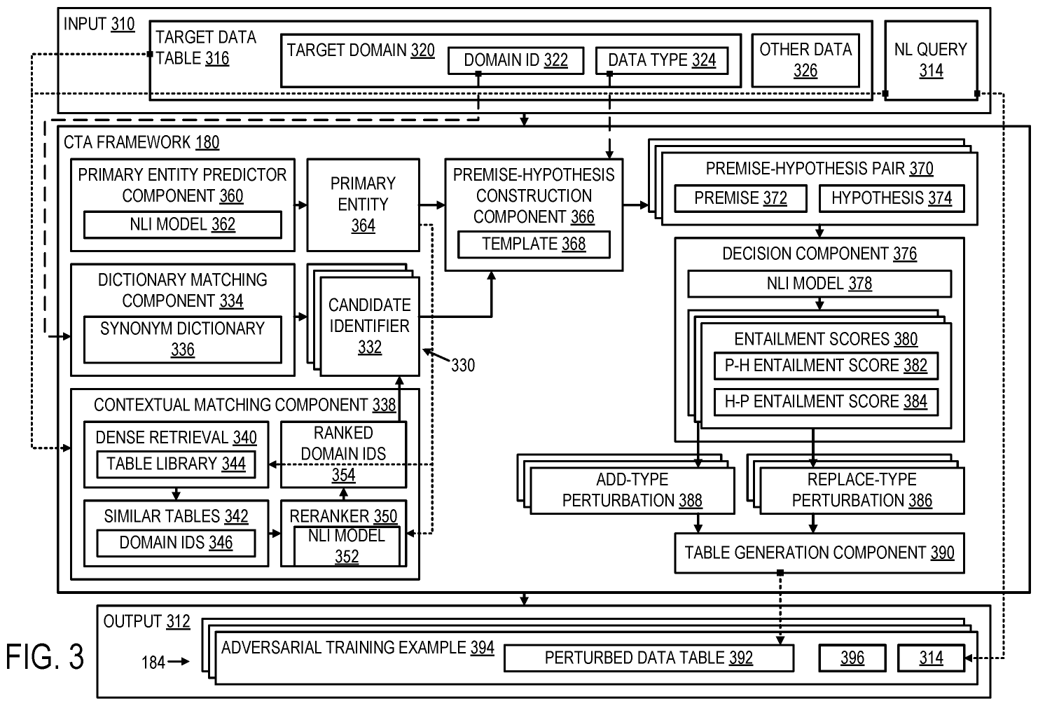

FIG. 3 depicts additional features of CTA framework 180 of FIG. 1. In this example, CTA framework 180 processes an example input 310 to generate an example output 312 that includes the set of one or more adversarial training examples 184 of FIG. 1 that may be used to train a query interpreter, such as query interpreter 130 of FIG. 1.

Input 310, in this example, includes an NL query 314 and a target data table 316 for the NL query. In at least some examples, target data table 316 may be identified based on NL query 314 by providing the NL query to the query interpreter (or an instance thereof) and receiving a result for the NL query from a database that identifies the target data table. In other examples, target data table 316 may be identified by a user as part of input 310.

Target data table 316 includes a target domain 320 (e.g., a target column) for NL query 314 among other domains (e.g., columns) of the target data table (represented in FIG. 3 by other data 326). Target domain 320 includes a domain identifier 322 and a data type 324 for associated data fields of the target domain. In at least some examples, target domain 320 may be identified based on NL query 314 by providing the NL query to the query interpreter (or an instance thereof) and receiving a result for the NL query from a database that identifies the target domain. In other examples, target domain 320 may be identified by a user as part of input 310.

CTA framework 180 obtains input 310, including NL query 314 and target data table 316, and generates a set of candidate identifiers 330 of which candidate identifier 332 is an example. Candidate identifiers 330 may be generated by CTA framework 180 using a variety of techniques, as in further described below.

As a first example of generating candidate identifiers, CTA framework 180 may include a dictionary matching component 334 that includes or has access to a synonym dictionary 336. As an example, synonym dictionary 336 defines an association between an input term and one or more synonym terms in which each synonym term exhibits a semantic association to the input term and varying levels of semantic equivalency (e.g., low or high semantic equivalency) to the input term. Dictionary matching component 334 may generate at least some candidate identifiers of the set of candidate identifiers 330 by identifying one or more synonyms for domain identifier 322 of target domain 320. As an example, if domain identifier 322 includes the term: “STUDENT”, dictionary matching component 334 may generate a candidate identifier that includes the term: “PUPIL” based on a synonym association defined between the terms “STUDENT” and “PUPIL” within synonym dictionary 336.

As a second example of generating candidate identifiers, CTA framework 180 may include a contextual matching component 338. In this example, contextual matching component 338 performs dense retrieval 340 of one or more similar data tables 342 that are contextually similar to target data table 316 from a data table library 344 based on contextual information provided by NL query 314 and/or target data table 316 of input 310.

Data table library 344 may form part of contextual matching component 338 in some examples. Additionally or alternatively, data table library 344 may be accessed by contextual matching component 338 from another resource (e.g., over a communications network or from a local data store). Data table library 344 may include hundreds, thousands, millions, or more data tables that span a variety of contexts (e.g., topics, subject matter, etc.). In at least some examples, similar tables 342 may include the top “K” number of similar tables identified by dense retrieval 340 from data table library 344, where “K” is a variable representing any suitable quantity. The variable “K” may be user-defined in at least some examples, thereby enabling administrator users to vary a quantity of similar data tables 342 that are evaluated for the set of candidate identifiers 330.

Similar tables 342 may each include one or more domain identifiers 346 for respective domains within each data table that are identified by contextual matching component 338. At least some of domain identifiers 346 may be identified by contextual matching component 338 as being semantically associated with domain identifier 322 of target domain 320. As an example, domain identifiers 346 of similar data tables 342 may be extracted and provided to a reranker 350 that generates a ranked set of the domain identifiers 346 of similar tables 342.

In at least some examples, a top “N” number of ranked domain identifiers 354 from among domain identifiers 346 may be added to the set of candidate identifiers 330, where “N” is a variable representing any suitable quantity. As an example, contextual matching component 338 may select at least some of the set of candidate identifiers 330 as a subset (e.g., a contextually-related subset) of the ranked set of domain identifiers 354 exhibiting greater semantic similarity. The variable “N” may be user-defined in at least some examples, thereby enabling administrator users to vary a quantity of candidate identifiers that are added to the set of candidate identifiers 330 from dense retrieval 340. As an illustrative example, the top 20 (where “N”=20) ranked domain identifiers 354 may be included in the set of candidate identifiers 330.

In at least some examples, reranker 350 may include or interface with an NLI model 352, such as described in further detail with reference to NLI models 362 and 378 to identify semantic associations between domain identifiers 346 and domain identifier 322 of target domain 320. Additionally, as described in further detail with reference to primary entity predictor component 360, dense retrieval 349 of similar data tables 342 and/or ranked domain identifiers 354 generated by reranker 350 may be based on a primary entity 364 identified for target data table 316, as an additional example of contextual information obtain from the target data table.

CTA framework 180 may include a primary entity predictor component 360 that identifies a primary entity 364 of target data table 316. In some examples, target data table 316 explicitly defines or otherwise identifies primary entity 364, such as by a domain identifier and/or other data 326 (e.g., a table caption) of the target data table. However, in other examples, target data table 316 does not explicitly define or otherwise identify primary entity 364. In these examples, primary entity predictor component 360 may use an NLI model 362 to predict primary entity 364 based on target data table 316.

As an example, primary entity predictor component 360 may use NLI model 362 to generate some or all of a contradiction score, a neutral score, and an entailment score for each of a plurality of premise-hypothesis pairs constructed for a plurality of predefined classes. In at least some examples, NLI model 362 may take the form of an MNLI model.

Each class of the plurality of predefined classes may be represented as a candidate label for that class. The premise of these premise-hypothesis pairs may include a concatenated form of one or more of the following: a table caption, some or all domains (e.g., columns), and some or all field values; and each hypothesis may include the candidate label of a class of the plurality of predefined classes. As an example, primary entity 364 identified for target data table 316 may be selected from a set of 60 or more predefined classes. However, other suitable quantities of classes may be used. In at least some examples, domains and/or field values may be randomly sampled from the target data table for inclusion in the premise of the premise-hypothesis pair used to classify the target data table as belong to a particular class.

Based on some or all of a contradiction score, a neutral score, and an entailment score of each of the plurality of premise-hypothesis pairs, primary entity predictor component 360 may classify target data table 316 as belonging to a select class of the plurality of predefined classes. As an example, some or all of the contradiction score, the neutral score, and the entailment score may be combined into a final score for purposes of ranking classes using a function.

In at least some examples, primary entity predictor component 360 may perform single shot classification to identify primary entity 364 for the target data table. The select class, in this example, may have the highest ranking among the plurality of predefined classes indicative of the greatest similarity between the target data table and the select class. Primary entity predictor component 360 may output primary entity 364 as the select class to which target data table 316 was classified.

Primary entity 364 may be used by a premise-hypothesis construction component 366 to generate a premise-hypothesis pair for each candidate identifier of the set of candidate identifiers 330. As an example, premise-hypothesis construction component 366 may generate premise-hypothesis pair 370 having a premise 372 and a hypothesis 374 for candidate identifier 332. Additionally, primary entity 364 may be used by contextual matching component 338 to identify similar data tables 342 and/or ranked domain identifiers 354.

Premise-hypothesis construction component 366 may use a template 368 to generate each premise-hypothesis pair. As an example, template 368 may define the premise of each premise-hypothesis pair as including an identifier of the primary entity and the identifier of the target domain, and may define the hypothesis of each premise-hypothesis pair as including the identifier of the primary entity and a candidate identifier of the set of candidate identifiers 330. For example, the premise may take the form of {primary entity 364} {domain identifier 322}, and the hypothesis may take the form of {primary entity 364} {the candidate identifier (e.g., 332)}. Additionally, in at least some examples, template 368 may define the premise and hypothesis of each premise-hypothesis pair as further including data type 324 of the data fields of target domain 320. For example, the premise may take the form of {primary entity 364} {domain identifier 322} ({data type 324}), and the hypothesis may take the form of {primary entity 364} {the candidate identifier (e.g., 332)} ({data type 324}).

CTA framework 180 may further include a decision component 376 that receives and processes each premise-hypothesis pair constructed for the set of candidate identifiers 330 to obtain one or more entailment scores that premise-hypothesis pair. Decision component 376 may include an NLI model 378 that generates one or more entailment scores for each premise-hypothesis pair. For example, premise-hypothesis pair 370 may be provided to NLI model 378 to generate entailment scores 380 for that pair. In at least some examples, NLI model 378 may take the form of an MNLI model.

As an example, the one or more entailment scores generated for each premise-hypothesis pair include: a premise-hypothesis entailment score (e.g., 382) (i.e., a forward entailment, referred to as “e1”) for the premise-hypothesis pair, and/or a hypothesis-premise entailment score (e.g., 384) (i.e., a backward entailment, referred to as “e2”) for the premise-hypothesis pair. The hypothesis-premise entailment score (e2) computation takes the hypothesis (containing the contextualized candidate identifier) as the premise input to the NLI model and the premise (containing the contextualized identifier of the target domain) as the hypothesis input to the NLI model, thereby providing a measure of probability of semantic equivalency in an opposite direction as compared to the premise-hypothesis entailment score (e1). The hypothesis-premise entailment score (e2) may be used in combination with the premise-hypothesis score (e1) to account for entailment score fluctuations caused by reversion.

Decision component 376 classifies the candidate identifier of each premise-hypothesis pair as being suitable for either an add-type perturbation or a replace-type perturbation based on the one or both of the entailment scores. By using both forward and backward measures of entailment (e1, e2 respectively), estimates of semantic equivalency generated by NLI models may be improved over use of a single entailment score. For example, within FIG. 3, a first set of entailment scores 380 are classified as a replace-type perturbation 386, whereas another set of entailment scores 382 are classified as an add-type perturbation 388 based on the one or both of the entailment scores generated for each premise-hypothesis pair.

As an example, classification of candidate identifiers by decision component 376 as being suitable for either add-type or replace-type perturbations may include determining whether one or both of a candidate identifier's entailment scores satisfy a replace criteria indicative of a semantic equivalency greater than a first threshold (e.g., e1 and e2 are both greater than or equal to 0.65 or other suitable value on a scale of 0 to 1.0), or whether one or both of a candidate identifier's entailment scores satisfy an add criteria indicative of a non-equivalent semantic similarity in which the semantic equivalency value is less than a second threshold (e.g., e1 and e2 are both less than or equal to 0.45 or other suitable value on a scale of 0 to 1.0). The second threshold may be less than or equal to the first threshold of the replace criteria. It will be understood that the first threshold associated with the replace criteria and the second threshold associated with the add criteria may be defined to have other suitable values from the examples provided herein. Such threshold values may be selected based on a particular language (e.g., English, Spanish, Japanese, etc.) being used for NL queries (e.g., NL query 314), and these threshold values may vary across languages or contexts (e.g., types of databases, subject matter, etc.).

CTA framework 180 may include a table generation component 390 that, for each candidate identifier classified as being suitable for an add-type perturbation or a replace-type perturbation, applies the candidate identifier to an instance of the target data table as either the add-type or replace type of table perturbation to generate a perturbed data table. For example, within FIG. 3, table generation component 390 generates a perturbed data table 392 that corresponds to candidate identifier 332 replacing domain identifier 322 of target domain 320. As an example, candidate identifier 332 includes the term “PUPIL”, and domain identifier 322 of target domain 320 includes the term “STUDENT” that is replaced by the term “PUPIL” within perturbed data table 392.

Perturbed data tables, such as 392 may be output by CTA framework 180 as part of an adversarial training. For example, perturbed data table 392 is output in FIG. 3 as part of adversarial training examples 394 of the set of adversarial training examples 184. In at least some examples, each adversarial training example may further include the NL query for which the perturbed data tables were generated and the target data table or an identifier of the target data table. For example, adversarial training example 394 includes NL query 314 and target data table information 396, which may include the target data table, a portion thereof, or an identifier of the target data table (e.g., from other data 326) that enables the query interpreter to reference the target data table as part of training. NL query 314 and target data table information 396 may represent training labels included in the adversarial training examples for use during training of the query interpreter.

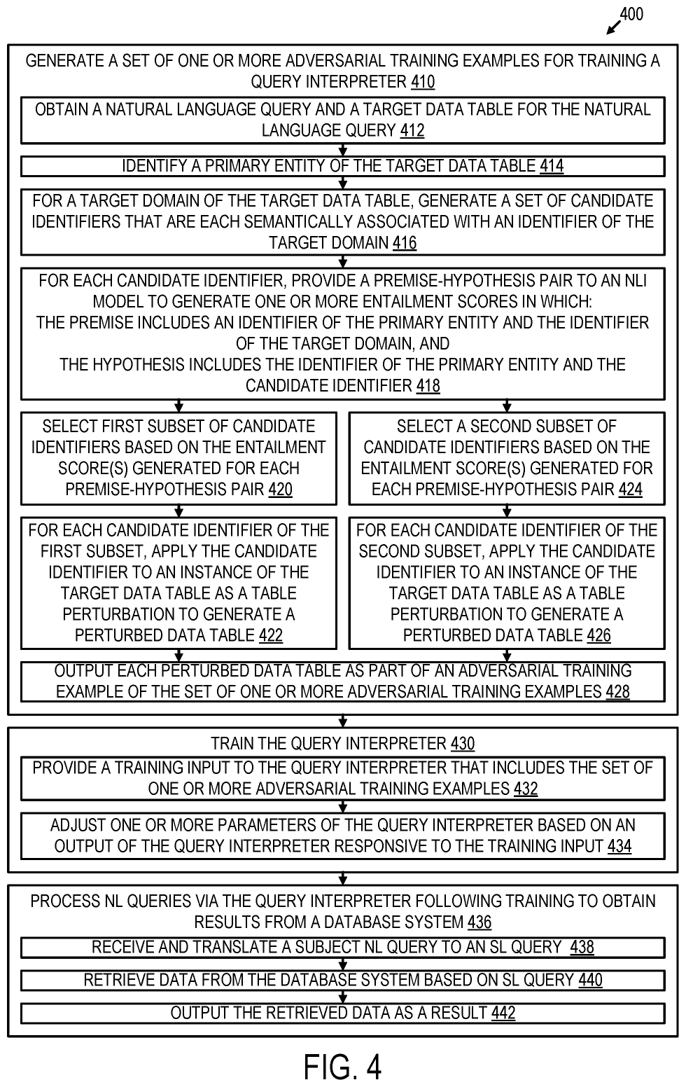

FIG. 4 is a flow diagram depicting an example method 400 to facilitate training of a computer-implemented query interpreter for a database system. Method 400 or portions thereof may be performed by a computing system of one or more computing devices. As an example, method 400 may be performed by a computing system executing or otherwise implementing CTA framework 180 of FIGS. 1 and 3.

At 410, the method includes generating a set of one or more adversarial training examples for training the query interpreter. Query interpreter 130 of FIG. 1 (e.g., an NL-SL query interpreter) is an example of a query interpreter that may be trained using adversarial training examples generated by method 400. Operations 412-428 described below may be performed as part of generating the set of adversarial training examples at 410.

At 412, the method includes obtaining an NL query and a target data table for the natural language query. In at least some examples, the target data table may be identified within a database system among a plurality of data tables based on the NL query by providing the NL query to the query interpreter (or an instance thereof) and receiving a result responsive to the NL query from the database system that identifies the target data table. In other examples, the target data table may be identified by a user as part of an input received by the CTA framework.

At 414, the method includes identifying a primary entity of the target data table. In at least some examples, the primary entity may be identified based on an explicit primary entity identifier of the target data table. For example, the primary entity may be defined based on information contained within the target data table (e.g., a table caption or a domain identifier). However, in at least some examples, the target data table may not include an explicit primary entity identifier. In these examples, the primary entity may be identified by classifying the target data table into a select class, as previously described with reference to primary entity predictor component 360 of FIG. 3.

At 416, the method includes, for a target domain (e.g., a target column) of the target data table, generating a set of candidate identifiers that are each semantically associated with an identifier of the target domain. In at least some examples, the target domain may be identified based on the NL query by providing the NL query to the query interpreter (or an instance thereof) and receiving a result for the NL query from the database system that identifies the target domain. In other examples, the target domain may be identified by a user as part of an input to the CTA framework.

As previously described with reference to dictionary matching component 334 of FIG. 3, at least some candidate identifiers of the set of candidate identifiers may be identified from a synonym dictionary based on the identifier of the target domain. As another example, at least some candidate identifiers of the set of candidate identifiers may be identified by contextual matching component 338 of FIG. 3 performing dense retrieval of similar data tables, and by reranking candidate domain identifiers contained in the similar data tables to identify the “K” most semantically similar candidate identifiers to the identifier of the target domain.

At 418, the method includes, for each candidate identifier, providing a premise-hypothesis pair to a natural language inference (NLI) model to generate one or more entailment scores. As an example, the premise of the premise-hypothesis pair may include an identifier of the primary entity and the identifier of the target domain, and the hypothesis of the premise-hypothesis pair may include the identifier of the primary entity and the candidate identifier. In at least some examples, the premise and the hypothesis may each further include a data type of the target domain.

In at least some examples, each entailment score may take the form of a value between zero and one that represents a probability of semantic equivalency. An entailment score generated for each premise-hypothesis pair may include a premise-hypothesis entailment score (referred to as e1) for the premise-hypothesis pair. Alternatively or additionally, an entailment score generated for each premise-hypothesis pair may include a hypothesis-premise entailment score (referred to as e2) for the premise-hypothesis pair.

At 420, the method includes selecting a first subset of candidate identifiers from among the set of candidate identifiers based on the one or more entailment scores (e.g., e1 and/or e2) generated for each premise-hypothesis pair. The first subset of candidate identifiers may be used for replace-type or for add-type perturbations. As an example, for replace-type perturbations, each candidate identifier of the first subset may be selected based on its one or more entailment scores satisfying a replace criteria indicative of a semantic equivalency greater than a first threshold (e.g., 0.65 or other suitable value) between the identifier of the target domain and the candidate identifier. As another example, for add-type perturbations, each candidate identifier of the first subset may be selected based on its one or more entailment scores satisfying an add criteria indicative of a semantic equivalency less than a first threshold (e.g., 0.45 or other suitable value) between the identifier of the target domain and the candidate identifier of the first subset.

At 422, the method includes, for each candidate identifier of the first subset, applying the candidate identifier to an instance of the target data table as a table perturbation to generate a perturbed data table. For replace-type perturbations, the candidate identifier may replace the identifier of the target domain to generate the perturbed data table. For add-type perturbations, the candidate identifier may be added to a new domain (e.g., a new column) that is not present in the target data table to generate the perturbed data table.

Operations 420 and 422 used to generate either add-type or replace-type table perturbations may be similarly performed at operations 424 and 426 for the other of the add-type or replace-type table perturbations using the appropriate criteria—e.g., add criteria for add-type perturbations and replace criteria for replace-type perturbations. For example, at 424, the method includes selecting a second subset of candidate identifiers based on the one or more entailment scores generated for each premise-hypothesis part. At 426, the method includes, for each candidate identifier of the second subset, applying the candidate identifier to an instance of the target data table as a table perturbation to generate a perturbed data table.

At 428, the method includes outputting each perturbed data table generated from operations 422 and 426 as part of an adversarial training example of the set of one or more adversarial training examples. In at least some examples, each adversarial training example further includes the natural language query and the target data table, a portion thereof, or an identifier of the target data table that enables the target data table to be accessed from the database system as part of training.

It will be understood that operation 410 may be performed a plurality of times using a plurality of different natural language queries across a plurality of different data tables to generate additional adversarial training examples that can be used to train the query interpreter. As an example, operation 410 may be performed across hundreds, thousands, millions, or more natural language queries and/or data tables to generate a training library of any suitable quantity of adversarial training examples.

At 430, the method includes training the query interpreter. As part of training the query interpreter at 430, the method includes providing a training input to the query interpreter that includes the set of one or more adversarial training examples at 432; and adjusting one or more parameters of the query interpreter based on an output of the query interpreter responsive to the training input at 434.

In at least some examples, training of the query interpreter may be performed using a machine learning framework that evaluates performance of the query interpreter based on training labels included in the adversarial training examples. As an example, the training labels may include the NL query (e.g., 314 of FIG. 3) and target data table information 396. The machine learning framework may identify and/or perform adjustments to one or more parameters of the query interpreter based on the performance evaluated on results returned from the perturbed data table (e.g., 392 of FIG. 3) of each adversarial training example.

At 436, the method includes processing NL queries via the query interpreter or an instance thereof following training at operation 430 to obtain results from a database system. As part of operation 436, the method may include: at the query interpreter, receive and translate a subject NL query to an SL query at 438, retrieve data from the database system based on the SL query 440 (e.g., by the query interpreter providing the SL query to a data retrieval engine of the database system for retrieval of the data), and output the retrieved data as a result at 442.

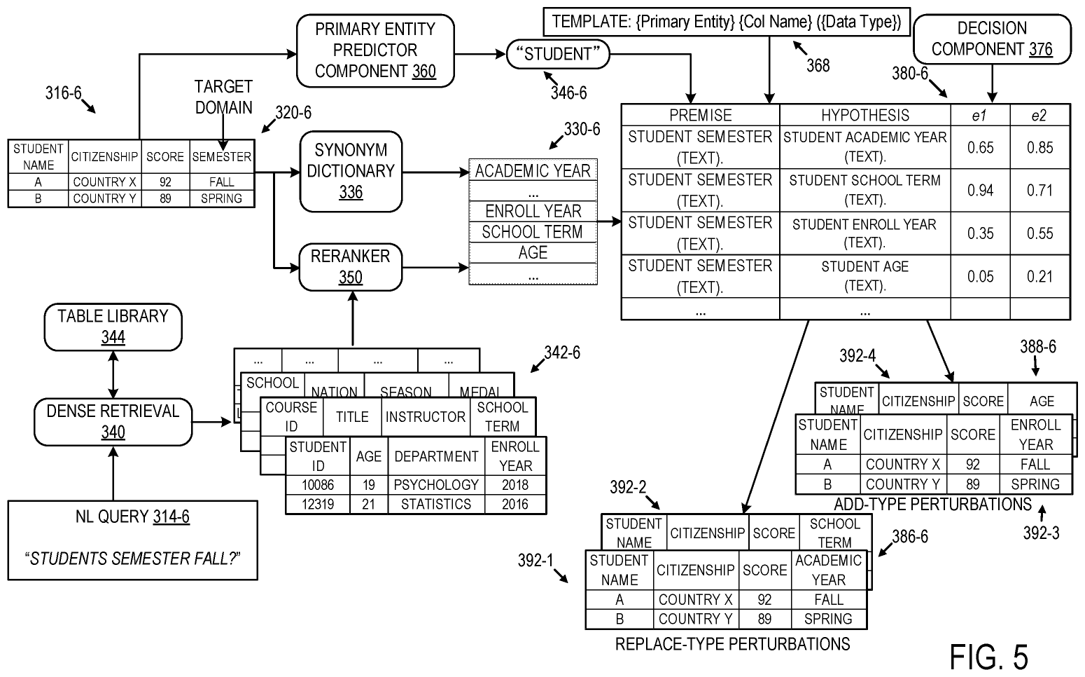

FIG. 5 depicts an example of contextualized table augmentation framework 180 of FIGS. 1 and 3 performing method 400 of FIG. 4 using an example natural language query 314-6 (e.g., “STUDENTS SEMESTER FALL?”) and target data table 316-6 having a target domain identifier 320-6 (e.g., “SEMESTER”). In this example, dense retrieval 340 is used to identify similar data tables 342-6 from data table library 344. Reranker 350 generates at least some candidate identifiers of the set of candidate identifiers 330-6, including “ENROLL YEAR”, “SCHOOL TERM”, and “AGE”, as examples. Synonym dictionary 336 is used to generate at least some candidate identifiers of the set of candidate identifiers 330-6 based on the target domain 320-6 (e.g., “SEMESTER”), including “ACADEMIC YEAR”, as an example. Primary predictor component 360 identifies “STUDENT” as primary entity 346-6 for target data table 316-6. Template 368 is used to generate premise-hypothesis pairs 380-6 for the set of candidate identifiers 330-6 and primary entity 346-6. In this example, template 368 further includes data type for the target domain as part of the premise-hypothesis pairs.

Decision component 376, in this example, classifies replace-type perturbations 386-6 as a first subset of premise-hypothesis pairs 380-6 that exhibit both entailment scores “e1” (the premise-hypothesis entailment score) and “e2” (the hypothesis-premise entailment score) generated by the NLI model of decision component 376 satisfying (e.g., being equal to or greater than) a first threshold of 0.65. Thus, replace-type perturbations 386-6 in this example include “SEMESTER” of the target domain being replaced with “ACADEMIC YEAR” and “SCHOOL TERM” in perturbed data tables 392-1 and 392-2, respectively.

Also in this example, decision component 376 classifies add-type perturbations 388-6 as a second subset of premise-hypothesis pairs 380-6 that exhibit both entailment scores “e1” (the premise-hypothesis entailment score) and “e2” (the hypothesis-premise entailment score) generated by the NLI model of decision component 376 satisfying (e.g., being equal to or less than) a second threshold of 0.55 that is less the first threshold of 0.65. Thus, add-type perturbations 388-6 in this example include “ENROLL YEAR” and “AGE” being added to new domains in perturbed data tables 392-3 and 392-4, respectively.

The methods and operations described herein may be tied to a computing system of one or more computing devices. In particular, such methods and operations may be implemented as a computer-application program or service, an application-programming interface (API), a library, and/or other computer-program product.

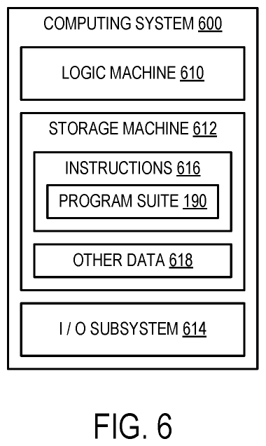

FIG. 6 is a schematic diagram of an example computing system 600 of one or more computing devices that can perform one or more of the methods and operations described herein. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 610, a storage machine 612, and an input/output subsystem 614.

Logic machine 610 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 612 includes one or more physical devices configured to hold instructions 616 and other data 618. Instructions 616 may include program suite 190, previously described with reference to FIG. 1. As an example, program suite 190 may include CTA framework 180. Instructions 616 are executable by logic machine 610 to perform the methods and operations described herein. When such methods and operations are performed, the state of storage machine 612 may be transformed—e.g., to hold different data. Other data 618, as an example, may include database 120 of FIG. 1 and other forms of data generated as part of the methods and operations disclosed herein.

Storage machine 612 may include removable and/or built-in devices. Storage machine 612 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 612 may include volatile, nonvolatile, dynamic, static, read/write, read-only, random-access, sequential-access, location-addressable, file-addressable, and/or content-addressable devices.

It will be appreciated that storage machine 612 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 610 and storage machine 612 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 610 executing instructions held by storage machine 612. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service” may be used to refer to an application program executable across multiple user sessions. A service may be available to one or more system components, programs, and/or other services. In some implementations, a service may run on one or more server-computing devices.

Input/output subsystem 614 may include one or more input devices, one or more output devices, one or more communication devices, etc. Computing system 600 may include or otherwise interface with a display subsystem, as an example of an output device of input/output subsystem 614. A display subsystem may be used to present a visual representation of data held by storage machine 612. This visual representation may take the form of a graphical user interface (GUI). As the herein described methods and processes change the data held by the storage machine, and thus transform the state of the storage machine, the state of the display subsystem may likewise be transformed to visually represent changes in the underlying data. The display subsystem may include one or more display devices utilizing virtually any type of technology. Such display devices may be combined with logic machine 110 and/or storage machine 112 in a shared enclosure, or such display devices may be peripheral display devices.

Input/output subsystem may include or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Input/output subsystem may include one or more communications devices configured to communicatively couple computing system 600 with one or more other computing devices. Communications devices may include wired and/or wireless communication devices compatible with one or more different communication protocols. As non-limiting examples, communications devices may be configured for communication via a wireless telephone network, or a wired or wireless local- or wide-area network. In some examples, communications devices of input/output subsystem 614 may allow computing system 600 to send and/or receive messages to and/or from other devices via a network such as the Internet.

According to an example of the present disclosure, a method to facilitate training of a computer-implemented query interpreter for a database system comprises: at a computing system, generating a set of one or more adversarial training examples for training the query interpreter by: obtaining a target data table for a natural language query; identifying a primary entity of the target data table; for a target domain of the target data table, generating a set of candidate identifiers that are each semantically associated with an identifier of the target domain; for each candidate identifier, providing a premise-hypothesis pair to a natural language inference (NLI) model to generate an entailment score in which: the premise of the premise-hypothesis pair includes an identifier of the primary entity and the identifier of the target domain, and the hypothesis of the premise-hypothesis pair includes the identifier of the primary entity and the candidate identifier; selecting a first subset of candidate identifiers from among the set of candidate identifiers based on the entailment score generated for each premise-hypothesis pair; for each candidate identifier of the first subset, applying the candidate identifier to an instance of the target data table as a table perturbation to generate a perturbed data table; and outputting each perturbed data table as part of an adversarial training example of the set of one or more adversarial training examples. In this example or other examples disclosed herein, the table perturbation for each candidate identifier of the first subset includes a replace-type perturbation in which the identifier of the target domain is replaced by the candidate identifier of the first subset; and wherein each candidate identifier of the first subset is selected based on its entailment score satisfying a replace criteria indicative of a semantic equivalency between the identifier of the target domain and the candidate identifier of the first subset. In this example or other examples disclosed herein, the method further comprises: selecting a second subset of candidate identifiers from among the set of candidate identifiers based on the entailment score generated for each premise-hypothesis pair; for each candidate identifier of the second subset, applying the candidate identifier to an instance of the target data table as a table perturbation to generate a perturbed data table of the set of one or more adversarial training examples; wherein the table perturbation for each candidate identifier of the second subset includes an add-type perturbation in which the candidate identifier of the second subset is added to a new domain within the perturbed data table that is not present in the target data table; wherein each candidate identifier of the second subset is selected based on its entailment score satisfying an add criteria indicative of a non-equivalent semantic similarity between the identifier of the target domain and the candidate identifier of the second subset. In this example or other examples disclosed herein, the table perturbation for each candidate identifier of the first subset includes an add-type perturbation in which the candidate identifier of the first subset is added to a new domain within the perturbed data table that is not present in the target data table; and each candidate identifier of the first subset is selected based on its entailment score satisfying an add criteria indicative of a non-equivalent semantic similarity between the identifier of the target domain and the candidate identifier of the first subset. In this example or other examples disclosed herein, the NLI model generates one or more entailment scores for each premise-hypothesis pair; and where the one or more entailment scores generated for each premise-hypothesis pair includes: a premise-hypothesis entailment score for the premise-hypothesis pair, and/or a hypothesis-premise entailment score for the premise-hypothesis pair. In this example or other examples disclosed herein, the query interpreter interprets natural language queries into structured queries of a structured query language; wherein the set of adversarial training examples each further include the natural language query used to generate each perturbed data table and the target data table, a portion thereof, or an identifier of the target data table; and wherein the method further comprises training the query interpreter by: providing the set of one or more adversarial training examples to the query interpreter as a training input; and adjusting one or more parameters of the query interpreter based on an output of the query interpreter responsive to the training input. In this example or other examples disclosed herein, generating the set of candidate identifiers that are each semantically associated with the identifier of the target domain includes: identifying, from a data table library, a plurality of similar data tables each having a primary entity that is semantically associated with or identical to the primary entity of the target data table; for each candidate data table of the plurality of candidate data tables, identifying a candidate domain within the candidate data table having a domain identifier that is semantically associated with the identifier of the target domain; ranking each domain identifier identified within the plurality of candidate data tables based on a semantic similarity between the domain identifier and the identifier of the target domain to obtain a ranked set of domain identifiers; and selecting at least some of the set of candidate identifiers as a subset of the ranked set of domain identifiers exhibiting greater semantic similarity. In this example or other examples disclosed herein, generating the set of candidate identifiers that are each semantically associated with the identifier of the target domain includes: identifying, from a synonym dictionary, at least some of the set of candidate identifiers based on a semantic similarity to the identifier of the target domain. In this example or other examples disclosed herein, the target domain is a column of the target data table, and the identifier of the target domain is a value within a column header of the column; wherein the premise of the premise-hypothesis pair provided to the NLI model for each candidate identifier further includes a data type of the target domain, and the hypothesis of the premise-hypothesis pair provided to the NLI model for each candidate identifier further includes the data type of the target domain. In this example or other examples disclosed herein, identifying the primary entity of the target data table includes, responsive to the target data table not explicitly identifying the primary entity: classifying the target data table into a select class of a plurality of predefined classes; and setting the identifier of the primary entity of the target data table as an identifier of the select class; wherein classifying the target data table includes: providing a table caption of the target data table, identifiers of one or more domains within the target data table, and one or more field values of each domain within the target data table to a Multi-NLI model; receiving as output from the Multi-NLI model for each of the plurality of predefined classes, one or more of a contradiction score, a neutral score, and an entailment score; and ranking the plurality of predefined classes based on a combination of one or more of the contradiction score, the neutral score, and the entailment score of each predefined class; wherein the select class has the highest ranking among the plurality of predefined classes.

According to another example of the present disclosure, a method performed by a computing system for processing natural language queries to structured language queries for a database system comprises: at a query interpreter: receiving a subject natural language query for the database system; translating the subject natural language query to a structure language query; and providing the structured language query to a data retrieval engine of the database system; wherein the query interpreter was previously trained using one or more adversarial training examples that were generated by a computer-implemented table augmentation framework that: obtains a target data table for a natural language query; identifies a primary entity of the target data table; for a target domain of the target data table, generates a set of candidate identifiers that are each semantically associated with an identifier of the target domain; for each candidate identifier, provides a premise-hypothesis pair to a natural language inference (NLI) model to generate an entailment score in which: the premise of the premise-hypothesis pair includes an identifier of the primary entity and the identifier of the target domain, and the hypothesis of the premise-hypothesis pair includes the identifier of the primary entity and the candidate identifier; selects a first subset of candidate identifiers from among the set of candidate identifiers based on the entailment score generated for each premise-hypothesis pair; for each candidate identifier of the first subset, applies the candidate identifier to an instance of the target data table as a table perturbation to generate a perturbed data table; and outputs each perturbed data table as part of an adversarial training example of the set of one or more adversarial training examples. In this example or other examples disclosed herein, the table perturbation for each candidate identifier of the first subset includes a replace-type perturbation in which the identifier of the target domain is replaced by the candidate identifier of the first subset; and wherein each candidate identifier of the first subset is selected based on its entailment score satisfying a replace criteria indicative of a semantic equivalency between the identifier of the target domain and the candidate identifier of the first subset. In this example or other examples disclosed herein, the table perturbation for each candidate identifier of the first subset includes an add-type perturbation in which the candidate identifier of the first subset is added to a new domain within the perturbed data table that is not present in the target data table; and wherein each candidate identifier of the first subset is selected based on its entailment score satisfying an add criteria indicative of a non-equivalent semantic similarity between the identifier of the target domain and the candidate identifier of the first subset. In this example or other examples disclosed herein, the NLI model generates one or more entailment scores for each premise-hypothesis pair; and wherein the one or more entailment scores generated for each premise-hypothesis pair includes: a premise-hypothesis entailment score for the premise-hypothesis pair, and/or a hypothesis-premise entailment score for the premise-hypothesis pair. In this example or other examples disclosed herein, the query interpreter interprets natural language queries into structured queries of a structured query language; and wherein the set of adversarial training examples each further include the natural language query used to generate each perturbed data table and the target data table, a portion thereof, or an identifier of the target data table. In this example or other examples disclosed herein, the method further comprises training the query interpreter by: providing the set of one or more adversarial training examples to the query interpreter as a training input; and adjusting one or more parameters of the query interpreter based on an output of the query interpreter responsive to the training input.

According to another example of the present disclosure, a computing system comprises: a storage machine having instructions stored thereon executable by a logic machine to: generate a set of one or more adversarial training examples for training a computer-implemented natural language-to-structured language query interpreter of a database system by: obtaining a target data table for a natural language query; identifying a primary entity of the target data table; for a target domain of the target data table, generating a set of candidate identifiers that are each semantically associated with an identifier of the target domain; for each candidate identifier, providing a premise-hypothesis pair to a natural language inference (NLI) model to generate an entailment score in which: the premise of the premise-hypothesis pair includes an identifier of the primary entity and the identifier of the target domain, and the hypothesis of the premise-hypothesis pair includes the identifier of the primary entity and the candidate identifier; selecting a first subset of candidate identifiers from among the set of candidate identifiers based on the entailment score generated for each premise-hypothesis pair; for each candidate identifier of the first subset, applying the candidate identifier to an instance of the target data table as a table perturbation to generate a perturbed data table; and outputting each perturbed data table as part of an adversarial training example of the set of one or more adversarial training examples. In this example or other examples disclosed herein, the table perturbation for each candidate identifier of the first subset includes a replace-type perturbation in which the identifier of the target domain is replaced by the candidate identifier of the first subset; and wherein each candidate identifier of the first subset is selected based on its entailment score satisfying a replace criteria indicative of a semantic equivalency between the identifier of the target domain and the candidate identifier of the first subset. In this example or other examples disclosed herein, the table perturbation for each candidate identifier of the first subset includes an add-type perturbation in which the candidate identifier of the first subset is added to a new domain within the perturbed data table that is not present in the target data table; and wherein each candidate identifier of the first subset is selected based on its entailment score satisfying an add criteria indicative of a non-equivalent semantic similarity between the identifier of the target domain and the candidate identifier of the first subset. In this example or other examples disclosed herein, the NLI model generates one or more entailment scores for each premise-hypothesis pair; and where the one or more entailment scores generated for each premise-hypothesis pair includes: a premise-hypothesis entailment score for the premise-hypothesis pair, and/or a hypothesis-premise entailment score for the premise-hypothesis pair.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method to facilitate training of a computer-implemented query interpreter for a database system, the method comprising:
at a computing system, generating a set of one or more adversarial training examples for training the query interpreter by:
obtaining a target data table for a natural language query;
identifying a primary entity of the target data table;
for a target domain of the target data table, generating a set of candidate identifiers that are each semantically associated with an identifier of the target domain;
for each candidate identifier, providing a premise-hypothesis pair to a natural language inference (NLI) model to generate an entailment score in which:
the premise of the premise-hypothesis pair includes an identifier of the primary entity and the identifier of the target domain, and
the hypothesis of the premise-hypothesis pair includes the identifier of the primary entity and the candidate identifier;
selecting a first subset of candidate identifiers from among the set of candidate identifiers based on the entailment score generated for each premise-hypothesis pair;
for each candidate identifier of the first subset, applying the candidate identifier to an instance of the target data table as a table perturbation to generate a perturbed data table; and
outputting each perturbed data table as part of an adversarial training example of the set of one or more adversarial training examples.

2. The method of claim 1, wherein the table perturbation for each candidate identifier of the first subset includes a replace-type perturbation in which the identifier of the target domain is replaced by the candidate identifier of the first subset; and
wherein each candidate identifier of the first subset is selected based on its entailment score satisfying a replace criteria indicative of a semantic equivalency between the identifier of the target domain and the candidate identifier of the first sub set.

3. The method of claim 2, further comprising:
selecting a second subset of candidate identifiers from among the set of candidate identifiers based on the entailment score generated for each premise-hypothesis pair; and
for each candidate identifier of the second subset, applying the candidate identifier to an instance of the target data table as a table perturbation to generate a perturbed data table of the set of one or more adversarial training examples;
wherein the table perturbation for each candidate identifier of the second subset includes an add-type perturbation in which the candidate identifier of the second subset is added to a new domain within the perturbed data table that is not present in the target data table;
wherein each candidate identifier of the second subset is selected based on its entailment score satisfying an add criteria indicative of a non-equivalent semantic similarity between the identifier of the target domain and the candidate identifier of the second subset.

4. The method of claim 1, wherein the table perturbation for each candidate identifier of the first subset includes an add-type perturbation in which the candidate identifier of the first subset is added to a new domain within the perturbed data table that is not present in the target data table; and
wherein each candidate identifier of the first subset is selected based on its entailment score satisfying an add criteria indicative of a non-equivalent semantic similarity between the identifier of the target domain and the candidate identifier of the first subset.

5. The method of claim 1, wherein the NLI model generates one or more entailment scores for each premise-hypothesis pair; and
where the one or more entailment scores generated for each premise-hypothesis pair includes:
a premise-hypothesis entailment score for the premise-hypothesis pair, and/or
a hypothesis-premise entailment score for the premise-hypothesis pair.

6. The method of claim 1, wherein the query interpreter interprets natural language queries into structured queries of a structured query language;
wherein the set of adversarial training examples each further include the natural language query used to generate each perturbed data table and the target data table, a portion thereof, or an identifier of the target data table; and
wherein the method further comprises training the query interpreter by:
providing the set of one or more adversarial training examples to the query interpreter as a training input; and
adjusting one or more parameters of the query interpreter based on an output of the query interpreter responsive to the training input.

7. The method of claim 1, wherein generating the set of candidate identifiers that are each semantically associated with the identifier of the target domain includes:
identifying, from a data table library, a plurality of similar data tables each having a primary entity that is semantically associated with or identical to the primary entity of the target data table;
for each candidate data table of the plurality of candidate data tables, identifying a candidate domain within the candidate data table having a domain identifier that is semantically associated with the identifier of the target domain;
ranking each domain identifier identified within the plurality of candidate data tables based on a semantic similarity between the domain identifier and the identifier of the target domain to obtain a ranked set of domain identifiers; and
selecting at least some of the set of candidate identifiers as a subset of the ranked set of domain identifiers exhibiting greater semantic similarity.

8. The method of claim 1, wherein generating the set of candidate identifiers that are each semantically associated with the identifier of the target domain includes:
identifying, from a synonym dictionary, at least some of the set of candidate identifiers based on a semantic similarity to the identifier of the target domain.

9. The method of claim 1, wherein the target domain is a column of the target data table, and the identifier of the target domain is a value within a column header of the column;
wherein the premise of the premise-hypothesis pair provided to the NLI model for each candidate identifier further includes a data type of the target domain, and
the hypothesis of the premise-hypothesis pair provided to the NLI model for each candidate identifier further includes the data type of the target domain.

10. The method of claim 1, wherein identifying the primary entity of the target data table includes, responsive to the target data table not explicitly identifying the primary entity:
classifying the target data table into a select class of a plurality of predefined classes; and
setting the identifier of the primary entity of the target data table as an identifier of the select class;
wherein classifying the target data table includes:
providing a table caption of the target data table, identifiers of one or more domains within the target data table, and one or more field values of each domain within the target data table to a Multi-NLI model;
receiving as output from the Multi-NLI model for each of the plurality of predefined classes, one or more of a contradiction score, a neutral score, and an entailment score; and
ranking the plurality of predefined classes based on a combination of one or more of the contradiction score, the neutral score, and the entailment score of each predefined class;
wherein the select class has the highest ranking among the plurality of predefined classes.

11. A method performed by a computing system for processing natural language queries to structured language queries for a database system, the method comprising:
at a query interpreter:
receiving a subject natural language query for the database system;
translating the subject natural language query to a structure language query; and
providing the structured language query to a data retrieval engine of the database system;
wherein the query interpreter was previously trained using one or more adversarial training examples that were generated by a computer-implemented table augmentation framework that:
obtains a target data table for a natural language query;
identifies a primary entity of the target data table;
for a target domain of the target data table, generates a set of candidate identifiers that are each semantically associated with an identifier of the target domain;
for each candidate identifier, provides a premise-hypothesis pair to a natural language inference (NLI) model to generate an entailment score in which:
the premise of the premise-hypothesis pair includes an identifier of the primary entity and the identifier of the target domain, and
the hypothesis of the premise-hypothesis pair includes the identifier of the primary entity and the candidate identifier;
selects a first subset of candidate identifiers from among the set of candidate identifiers based on the entailment score generated for each premise-hypothesis pair;
for each candidate identifier of the first subset, applies the candidate identifier to an instance of the target data table as a table perturbation to generate a perturbed data table; and
outputs each perturbed data table as part of an adversarial training example of the set of one or more adversarial training examples.

12. The method of claim 11, wherein the table perturbation for each candidate identifier of the first subset includes a replace-type perturbation in which the identifier of the target domain is replaced by the candidate identifier of the first subset; and
wherein each candidate identifier of the first subset is selected based on its entailment score satisfying a replace criteria indicative of a semantic equivalency between the identifier of the target domain and the candidate identifier of the first sub set.

13. The method of claim 11, wherein the table perturbation for each candidate identifier of the first subset includes an add-type perturbation in which the candidate identifier of the first subset is added to a new domain within the perturbed data table that is not present in the target data table; and
wherein each candidate identifier of the first subset is selected based on its entailment score satisfying an add criteria indicative of a non-equivalent semantic similarity between the identifier of the target domain and the candidate identifier of the first subset.

14. The method of claim 11, wherein the NLI model generates one or more entailment scores for each premise-hypothesis pair; and
where the one or more entailment scores generated for each premise-hypothesis pair includes:
a premise-hypothesis entailment score for the premise-hypothesis pair, and/or
a hypothesis-premise entailment score for the premise-hypothesis pair.

15. The method of claim 11, wherein the query interpreter interprets natural language queries into structured queries of a structured query language; and
wherein the set of adversarial training examples each further include the natural language query used to generate each perturbed data table and the target data table, a portion thereof, or an identifier of the target data table.

16. The method of claim 11, wherein the method further comprises training the query interpreter by:
providing the set of one or more adversarial training examples to the query interpreter as a training input; and
adjusting one or more parameters of the query interpreter based on an output of the query interpreter responsive to the training input.

17. A computing system, comprising:
a storage machine having instructions stored thereon executable by a logic machine to:
generate a set of one or more adversarial training examples for training a computer-implemented natural language-to-structured language query interpreter of a database system by:
obtaining a target data table for a natural language query;
identifying a primary entity of the target data table;
for a target domain of the target data table, generating a set of candidate identifiers that are each semantically associated with an identifier of the target domain;
for each candidate identifier, providing a premise-hypothesis pair to a natural language inference (NLI) model to generate an entailment score in which:
the premise of the premise-hypothesis pair includes an identifier of the primary entity and the identifier of the target domain, and
the hypothesis of the premise-hypothesis pair includes the identifier of the primary entity and the candidate identifier;
selecting a first subset of candidate identifiers from among the set of candidate identifiers based on the entailment score generated for each premise-hypothesis pair;
for each candidate identifier of the first subset, applying the candidate identifier to an instance of the target data table as a table perturbation to generate a perturbed data table; and
outputting each perturbed data table as part of an adversarial training example of the set of one or more adversarial training examples.

18. The computing system of claim 17, wherein the table perturbation for each candidate identifier of the first subset includes a replace-type perturbation in which the identifier of the target domain is replaced by the candidate identifier of the first subset; and
wherein each candidate identifier of the first subset is selected based on its entailment score satisfying a replace criteria indicative of a semantic equivalency between the identifier of the target domain and the candidate identifier of the first sub set.

19. The computing system of claim 17, wherein the table perturbation for each candidate identifier of the first subset includes an add-type perturbation in which the candidate identifier of the first subset is added to a new domain within the perturbed data table that is not present in the target data table; and
wherein each candidate identifier of the first subset is selected based on its entailment score satisfying an add criteria indicative of a non-equivalent semantic similarity between the identifier of the target domain and the candidate identifier of the first subset.

20. The computing system of claim 17, wherein the NLI model generates one or more entailment scores for each premise-hypothesis pair; and
where the one or more entailment scores generated for each premise-hypothesis pair includes:
a premise-hypothesis entailment score for the premise-hypothesis pair, and/or
a hypothesis-premise entailment score for the premise-hypothesis pair.
